(19) United States
(12) Patent Application Publication
(10) Pub. No.: US 2024/0151069 A1
(43) Pub. Date: May 9, 2024

(54) DOOR HANDLE AND LOCKING SYSTEM

(71) Applicant: Global Link Distribution, Corp., Elkhart, IN (US)

(72) Inventor: Christopher J. Waites, Frankenmuth, MI (US)

(73) Assignee: Global Link Distribution, Corp., Elkhart, IN (US)

(21) Appl. No.: 18/411,969

(22) Filed: Jan. 12, 2024

Related U.S. Application Data
(63) Continuation of application No. 16/987,545, filed on Aug. 7, 2020, now Pat. No. 11,873,667.
(60) Provisional application No. 62/883,997, filed on Aug. 7, 2019.

(51) Int. Cl. E05B 77/04; E05B 85/10

(52) U.S. Cl. CPC E05B 77/04; E05B 85/10; E05B 83/44

(57) ABSTRACT

A door handle and locking system includes a base, a latching mechanism, a handle, a safety latch mechanism, and a biasing member having a biasing force. The latching mechanism is movable from a latched position to an unlatched position. The handle is connected to the base and is movable in response to a first force from a first position to a second position. Moving the handle from the first position to the second position moves the latching mechanism from the latched position to the unlatched position. The safety latch mechanism moves from a first position to a second position upon application of a force to the biasing member exceeding the biasing force. The safety latch mechanism remains in the first position upon movement of the handle from the first position to the second position.

### CROSS-REFERENCE TO RELATED APPLICATIONS

This application is a continuation of and claims priority to U.S. patent application Ser. No. 16/987,545, filed Aug. 7, 2020 which claims priority to U.S. Provisional Patent Application No. 62/883,997 filed Aug. 7, 2019, both of which are incorporated herein in their entirety.

### BACKGROUND OF THE INVENTION

The present invention relates to a door handle and locking system and, in particular, to a door handle and locking system for a vehicle.

Certain safety standards, such as United States Federal Motor Vehicle Safety Standards, may require vehicle door latches to remain engaged under certain forces that may be experienced in an accident or during operation of the vehicle. For example, one FMVSS standard requires a vehicle door latch to remain engaged at up to 30 G force acting on the vehicle door handle in the X, Y and Z directions as defined by the handle's orientation in relation to the vehicle door.

### SUMMARY OF THE INVENTION

In one embodiment of the present invention, a safety latch mechanism for a vehicle door handle and locking system includes a body, a first post, and a second post. The body has a first end, a second end, and a mass having a first portion and a second portion. The first portion of the mass of the body is greater than the second portion of the mass of the body. An opening extends through the second portion of the mass of the body. The first post extends from the body at a location closer to the second end of the body than to the first end of the body. The second post extends from the body at a location closer to the second end of the body than to the first end of the body. The first portion of the mass of the body is located between the first post, the second post, and the first end of the body. The second portion of the mass of the body is located between the first post, the second post, and the second end of the body.

In one embodiment, the first portion of the mass of the body and the second portion of the mass of the body lie substantially in a common plane.

In another embodiment, the first portion of the mass of the body and the second portion of the mass of the body have substantially the same width.

In certain embodiments, the first portion of the mass of the body has a width, and the first portion of the mass of the body is solid across its width from the first and second posts to the first end of the body.

In other embodiments, the body is substantially linear from the first end to the second end.

In yet another embodiment, the opening is located at least partially between the first post and the second post.

In some embodiments, the safety latch mechanism further includes a spring for biasing the safety latch mechanism into a first position.

In one embodiment, the first and second posts are integrally formed with the body.

In one embodiment of the present invention, a safety latch mechanism for a vehicle door handle and locking system includes a body, a first post, and a second post. The body has a first end, a second end, and a mass having a first portion and a second portion. The first portion of the mass of the body is greater than the second portion of the mass of the body. The first portion of the mass of the body and the second portion of the mass of the body lie substantially in a common plane. The first post extends from the body at a location closer to the second end of the body than to the first end of the body. The second post extends from the body at a location closer to the second end of the body than to the first end of the body. The first portion of the mass of the body is located between the first post, the second post, and the first end of the body. The second portion of the mass of the body is located between the first post, the second post, and the second end of the body.

In one embodiment, the safety latch mechanism further includes an opening extending through the second portion of the mass of the body. In certain embodiments, the opening is located at least partially between the first post and the second post.

In another embodiment, the first portion of the mass of the body and the second portion of the mass of the body have substantially the same width.

In some embodiments, the first portion of the mass of the body has a width, and the first portion of the mass of the body is solid across its width from the first and second posts to the first end of the body.

In other embodiments, the body is substantially linear from the first end to the second end.

In one embodiments, the safety latch mechanism further includes a spring for biasing the safety latch mechanism into a first position.

In yet another embodiment, the first and second posts are integrally formed with the body.

Other features of the present invention will be apparent from a the following description of embodiments of the invention and the accompanying drawings.

### BRIEF DESCRIPTION OF THE DRAWINGS

FIG. 1 is a perspective view of a recreational vehicle equipped with a door handle and locking system according to one embodiment of the present invention.

FIG. 2 is a perspective view of a door handle and locking system according to one embodiment of the present invention.

FIG. 3 is a perspective view of the door handle and locking system shown in FIG. 2 illustrating the X, Y and Z axis of the door handle and locking system shown in FIG. 2.

FIG. 4 is a side view of certain components of the door handle and locking system shown in FIG. 2.

FIG. 5 is an elevational view of certain components of the door handle and locking system shown in FIG. 2.

FIG. 6 is a perspective view of certain components of the door handle and locking system shown in FIG. 2.

FIG. 7 is a perspective view of certain components of the door handle and locking system shown in FIG. 2.

FIG. 8 is an elevational view of certain components of the door handle and locking system shown in FIG. 2.

FIG. 9 is a perspective view of an actuator mechanism that is a component of the door handle and locking system shown in FIG. 2.

FIG. 10 is a perspective view of a safety latch mechanism that is a component of the door handle and locking system shown in FIG. 2.

FIG. 11 is a perspective view of a base that is a component of the door handle and locking system shown in FIG. 2.

### DETAILED DESCRIPTION OF EMBODIMENTS OF THE INVENTION

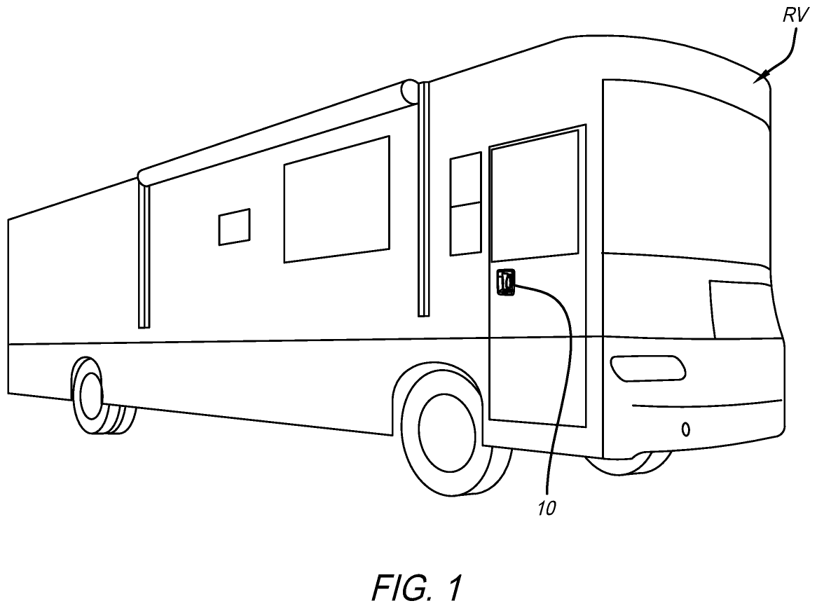

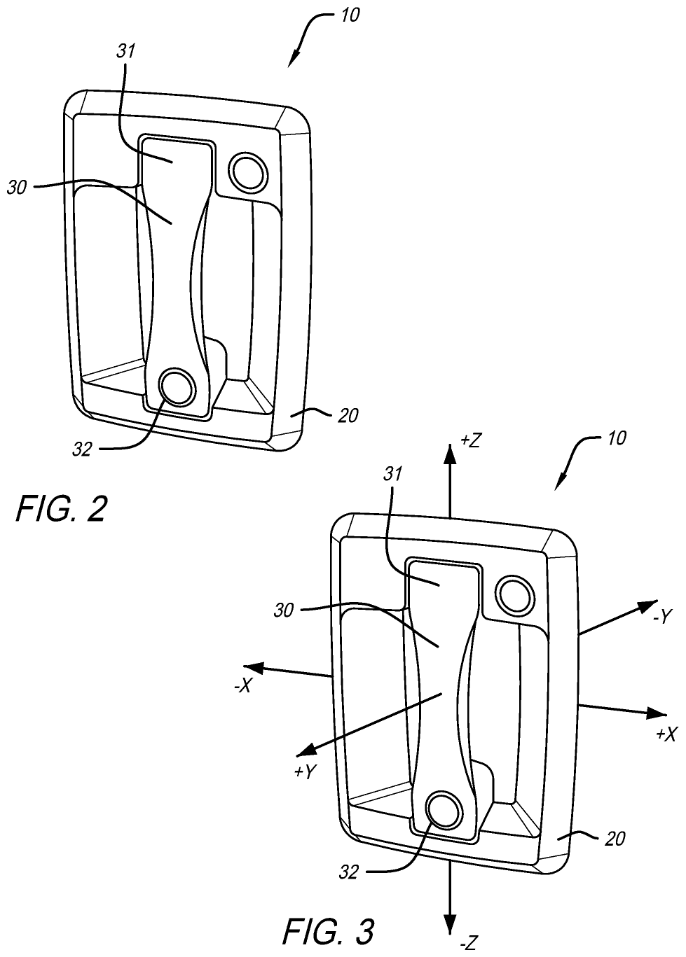

FIG. 1 is a perspective view of a recreational vehicle RV equipped with a door handle and locking system 10 according to one embodiment of the present invention. FIG. 2 is a perspective view of door handle and locking system 10. Solely for purposes of describing and illustrating door handle and locking system 10, FIG. 3 is a perspective view of door handle and locking system 10 with directional axes X, Y and Z indicated.

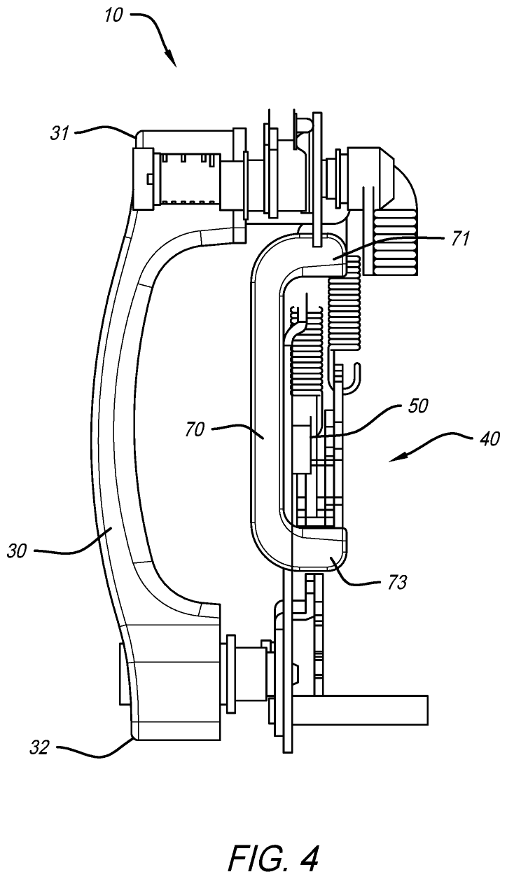

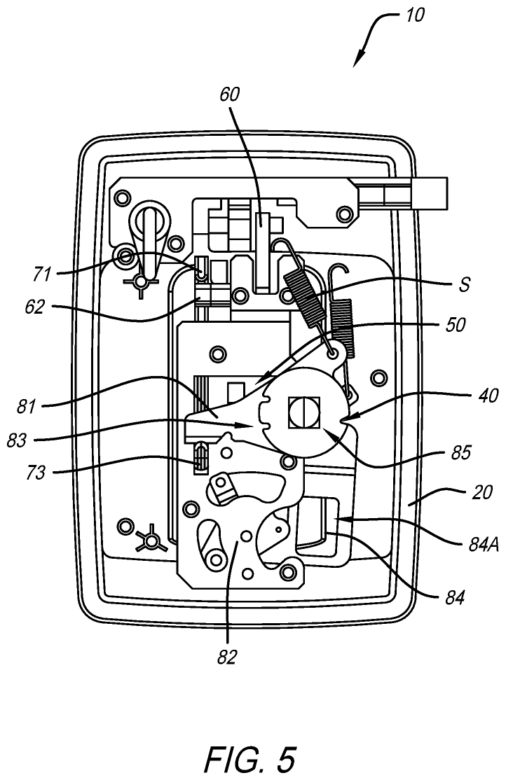

As shown in FIGS. 1-4, door handle and locking system 10 generally includes a base 20, a handle 30, a latching mechanism 40 and a safety latch mechanism 50. Note that FIG. 4 illustrates door handle and locking system 10 with base 20 removed so as to make internal components of door handle and locking system 10 visible.

Handle 30 includes a first end 31 and a second end 32. Handle 30 is connected to base 20 so as to permit first end 31 to be pulled away from base 20 and to move second end 32 toward base 20 so as to activate latching mechanism 40 to permit the door to which door handle and locking system 10 is attached to be opened.

As shown in FIGS. 4-8, latching mechanism 40 is supported by base 20. In the embodiment shown, latching mechanism 40 includes a first cam mechanism 60, an actuator mechanism 70, a second cam mechanism 80, and a rotary mechanism 90.

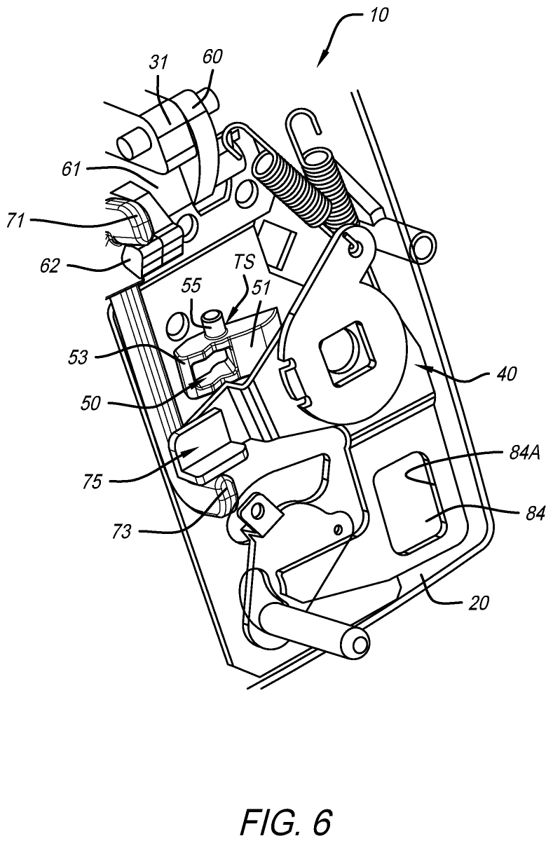

In the embodiment shown, first cam mechanism 60 includes a shaft 61 having a projection 62 extending therefrom (FIGS. 6-8).

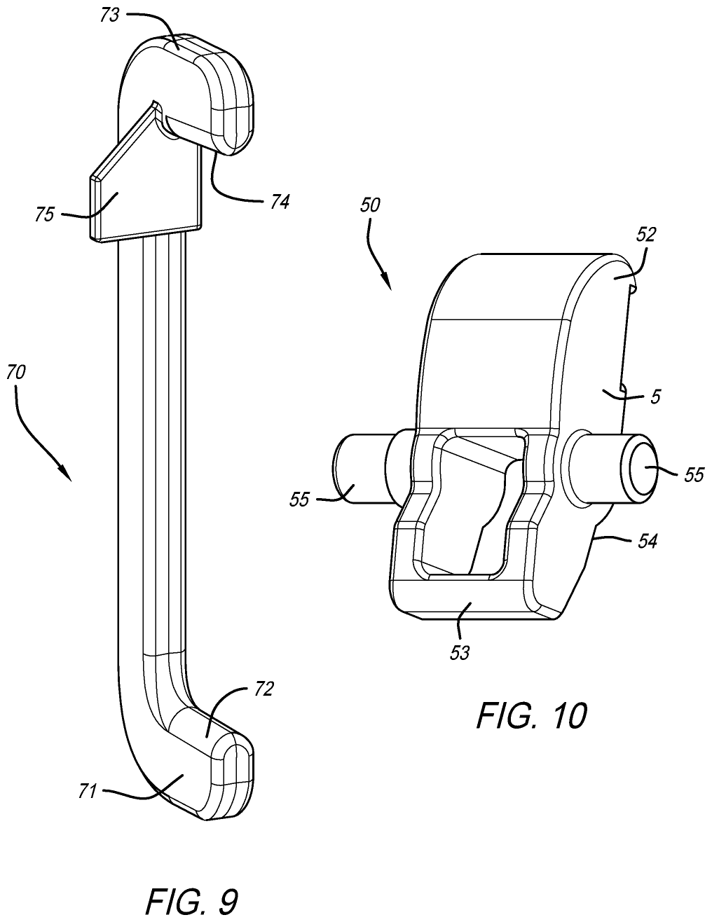

Actuator mechanism 70 (FIG. 9) is a generally C-shaped member having a first end 71 with a projection 72 extending therefrom, a second end 73 with a projection 74 extending therefrom, and a tab or projection 75. In the embodiment, shown tab or projection 75 is positioned adjacent second end 73 of actuator mechanism 70.

Second cam mechanism 80 in the embodiment shown is a generally C or a U-shaped member having a first arm 81, a second arm 82, a first opening 83, a second opening 84 having a side edge 84A, and a biasing member 85 having a projection 86 extending into first opening 83. A spring S biases biasing member 85 in the position shown in FIG. 2 when handle 30 is in the unactuated positon.

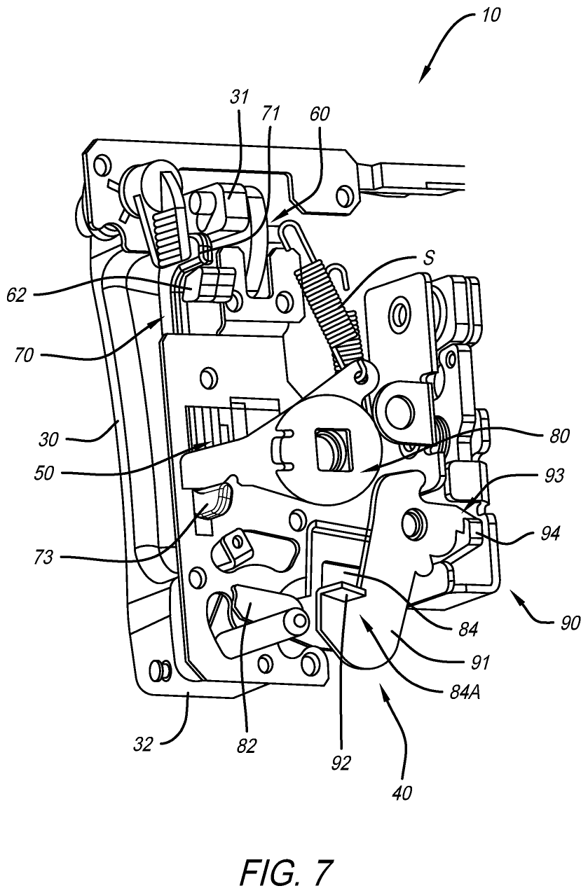

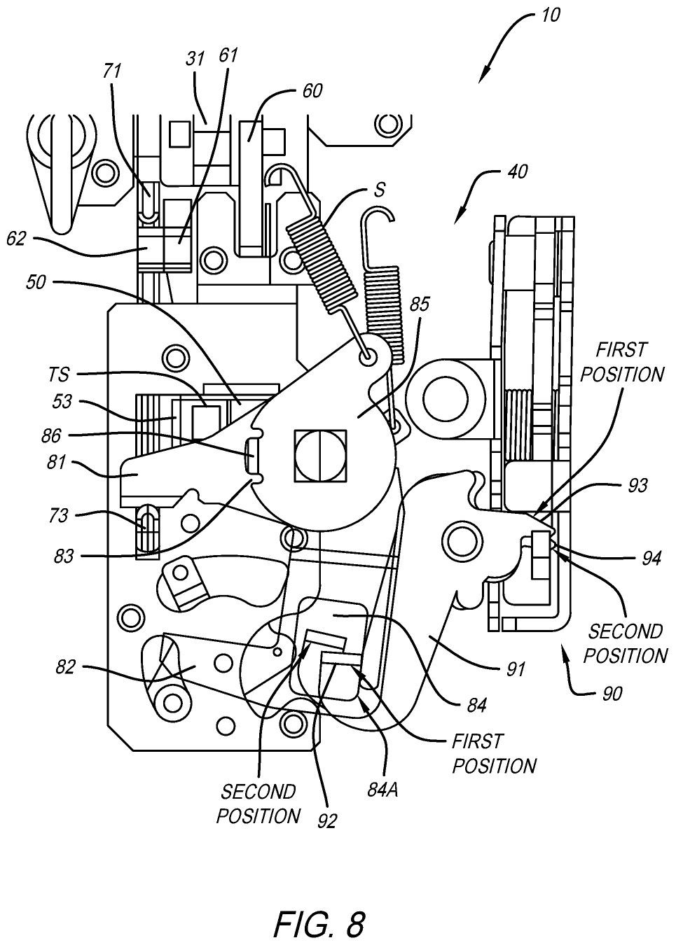

Rotary mechanism 90 (FIGS. 7 and 8) generally includes an actuator arm 91 having a first projection 92 that extends through second opening 84 in second cam mechanism 80 and a second projection 93 that engages a latch actuation mechanism 94.

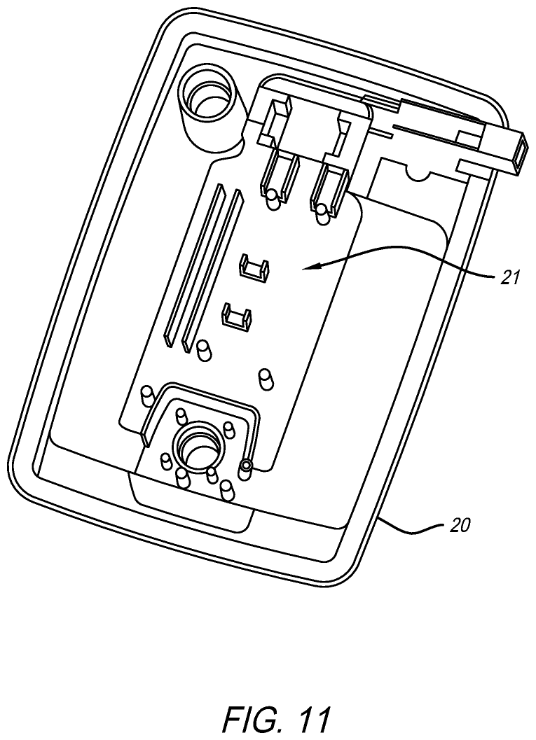

Safety latch mechanism 50 (FIG. 10) includes a body 51 having a first end 52, a second end 53, an opening 54, and a pair of posts or pins 55 extending from body 51. Note that in the embodiment shown, pins or posts 55 are positioned closer to second end 53 than to first end 52. Note also that safety latch mechanism 50 is configured such that the mass of safety latch mechanism 50 between pins or posts 55 and first end 52 is greater than the mass of safety latch mechanism 50 between pins or posts 55 and second end 53. Safety latch mechanism 50 is secured in base 20 by engaging pins or posts 55 with retaining members 21 in base 20. Safety latch mechanism 50 is secured in to base 20 in a manner that permits it to rotate about pins or posts 55. A torsion spring TS is positioned around one of the posts or pins 55. Torsion spring TS biases safety latch mechanism 50 into the position shown in FIG. 6 when handle 30 is in the unactuated position.

In operation, the vehicle door can be unlatched and opened by pulling on handle 30 so as to move first end 31 away from base 20. This causes rotation of first cam mechanism 60 and shaft 61, which causes upward movement of projection 62. As projection 62 moves upward, it draws actuator mechanism 70 upward by means of the engagement of projection 62 with projection 72 on first end 71 of actuator mechanism 70. As actuator mechanism 70 is drawn upwardly, projection 74 on second end 73 engages first arm 81 of second cam mechanism 80, thereby causing second cam mechanism 80 to rotate in a clockwise direction. As second cam mechanism 80 rotates, side edge 84A of second opening 84 bears against first projection 92 of actuator arm 91 to rotate actuator arm 91 in a clockwise direction so that first projection 92 moves from a first position to a second position in which first projection 92 is located above and to the left of the first position as shown in FIG. 5. This motion causes second projection 93 to move downwardly from a first position to a second position, thereby engaging latch actuation mechanism 94 and unlocking the door. Note that as this occurs, the inner edge of first opening 83 of second cam mechanism 80 engages projection 86 of biasing member 85 and rotates biasing member 85 clockwise, thereby stretching spring S. When handle 30 is released, second cam mechanism 80 will return to its unactuated position under the force of spring S.

As noted above, torsion spring TS biases safety latch mechanism 50 in the position shown in FIG. 3. Operation of handle 30 has no effect on the position of safety latch mechanism 50. However, if safety latch mechanism 50 experiences unintended force sufficient to overcome the biasing force of torsion spring TS, such as could occur during an accident, safety latch mechanism 50 will rotate about pins or posts 55 so as to position second end 53 in the path of travel of actuator mechanism 70. Tab or projection 75 of actuator mechanism 70 will engage second end 53 of safety latch mechanism 50, thereby preventing further movement of actuator mechanism 70. This in turn prevents full rotation of second cam mechanism 80, thereby preventing actuator arm 91 from rotating so as to engage latch actuation mechanism 94. Thus, the vehicle door will remain locked. Note that in certain embodiments of the invention, the force required to actuate door handle 30 manually exceeds that necessary to overcome the biasing force of torsion spring TS and to actuate safety latch mechanism 50. For example, in one embodiment of the present invention, approximately 13 G force is required to manually actuate handle 30 but only 3 G force is needed to overcome the biasing force of torsion spring TS and actuate safety latch mechanism 50.

Although the present invention has been shown and described in detail, the same is by way of example only and should not be taken as a limitation on the invention. Numerous modifications can be made to the embodiments disclosed without departing from the scope of the present invention.

What is claimed is:

1. A safety latch mechanism for a vehicle door handle and locking system, the safety latch mechanism including:
a body having a first end, a second end, and a mass having a first portion and a second portion, the first portion of the mass of the body being greater than the second portion of the mass of the body;
a first post extending from the body at a location closer to the second end of the body than to the first end of the body;
a second post extending from the body at a location closer to the second end of the body than to the first end of the body;
an opening extending through the second portion of the mass of the body; and
wherein the first portion of the mass of the body is located between the first post, the second post, and the first end of the body, and the second portion of the mass of the body is located between the first post, the second post, and the second end of the body.

2. The safety latch mechanism according to claim 1, wherein the first portion of the mass of the body and the second portion of the mass of the body lie substantially in a common plane.

3. The safety latch mechanism according to claim 1, wherein the first portion of the mass of the body and the second portion of the mass of the body have substantially the same width.

4. The safety latch mechanism according to claim 1, wherein the first portion of the mass of the body has a width, and the first portion of the mass of the body is solid across its width form the first and second posts to the first end of the body.

5. The safety latch mechanism according to claim 1, wherein the body is substantially linear from the first end to the second end.

6. The safety latch mechanism according to claim 1, wherein the opening is located at least partially between the first post and the second post.

7. The safety latch mechanism according to claim 1, further including a spring for biasing the safety latch mechanism into a first position.

8. The safety latch mechanism according to claim 1, wherein the first and second posts are integrally formed with the body.

9. A safety latch mechanism for a vehicle door handle and locking system, the safety latch mechanism including:
a body having a first end, a second end, and a mass having a first portion and a second portion, the first portion of the mass of the body being greater than the second portion of the mass of the body, the first portion of the mass of the body and the second portion of the mass of the body lying substantially in a common plane;
a first post extending from the body at a location closer to the second end of the body than to the first end of the body;
a second post extending from the body at a location closer to the second end of the body than to the first end of the body; and
wherein the first portion of the mass of the body is located between the first post, the second post, and the first end of the body, and the second portion of the mass of the body is located between the first post, the second post, and the second end of the body.

10. The safety latch mechanism according to claim 9, further including an opening extending through the second portion of the mass of the body.

11. The safety latch mechanism according to claim 10, wherein the opening is located at least partially between the first post and the second post.

12. The safety latch mechanism according to claim 9, wherein the first portion of the mass of the body and the second portion of the mass of the body have substantially the same width.

13. The safety latch mechanism according to claim 9, wherein the first portion of the mass of the body has a width, and the first portion of the mass of the body is solid across its width from the first and second posts to the first end of the body.

14. The safety latch mechanism according to claim 9, wherein the body is substantially linear from the first end to the second end.

15. The safety latch mechanism according to claim 9, further including a spring for biasing the safety latch mechanism into a first position.

16. The safety latch mechanism according to claim 9, wherein the first and second posts are integrally formed with the body.
